(19) United States
(12) Patent Application Publication
(10) Pub. No.: US 2015/0095199 A1
(43) Pub. Date: Apr. 2, 2015

(54) QUICK ROUTE QUEUED PRODUCTS AND SERVICES

(71) Applicant: Wal-Mart Stores, Inc., Bentonville, AR (US)

(72) Inventor: Richard M. Blair, II, Centerton, AR (US)

(73) Assignee: Wal-Mart Stores, Inc., Bentonville, AR (US)

(21) Appl. No.: 14/038,850

(22) Filed: Sep. 27, 2013

(51) Int. Cl. G06Q 30/06

(52) U.S. Cl. CPC G06Q 30/0635
USPC 705/26.81

(57) ABSTRACT

A system and computer implemented consumer time saving method includes access to a computer application resident on an user device or via a webpage to order a product or service via a wireless network by: selecting a product or service; selecting two or more stores at locations where the selected product or service is available; determining an estimated pick-up or service time at each of the selected stores; selecting one of the store locations to order the selected product or service; and ordering the selected product or service at the selected store location.

### FIELD OF THE INVENTION

The present invention relates generally to a consumer time saving system and method applicable in its broadest sense to purchasing and picking up any queued products, and purchasing and facilitating any services, and more specfically to purchasing and picking up queued pharmacy products and services.

### BACKGROUND

Stores that sell products and/or services inevitably have customer wait times for delivery or pick-up of product purchases, and for services to be rendered and completed. In one example, stores may offer products that require or optionally offer assembly or set-up prior to or after purchase, delivery or pick-up of the products. In another example, stores may offer products that are back-ordered and unavailable for pick-up or delivery until a given or estimated date and time. In yet another example a product may need warranty work or repair whereby the time for completion of the warranty work or repair may vary depending upon where the work will be done.

A queued service such as but not limited to filling a prescription at a pharmacy which is part of a chain of stores (or stores which interact with one another) may have varying completion times for filling the prescription depending upon a number of factors such as the number of pharmacists on duty, the hours of operation of each pharmacy, the number of prescriptions in a queue waiting to be re-filled, etc. In another example, automobile service such as repairs and routine maintenance also vary from one location to another depending upon scheduling of work to be done, availability of mechanics and other employees, employee lunch breaks, requirements for other services (such as pumping gas, clerical duties, answering the phone, etc.) by the company employees, etc.

In view of the many factors which effect product or service availability, delivery or pick-up times, service completion times, warranty completion times, etc. there is a need and desire for a system and method to help customers be aware of estimated times for product and service availability, delivery and completion.

### BRIEF SUMMARY OF EMBODIMENTS

A system and computer implemented consumer time saving method includes access to a computer application resident on an user device or via a webpage to order a product or service via a wireless network by: selecting a product or service; selecting two or more stores at locations where the selected product or service is available; determining an estimated pick-up or service time at each of the selected stores; selecting one of the store locations to order the selected product or service; and ordering the selected product or service at the selected store location.

A computer implemented consumer time saving method includes the steps of: accessing, by a consumer, a computer application for ordering or purchasing products or services available from a company using a computer device connected to a wireless network; selecting, by the consumer via the application, one of the available products or services for consideration of ordering or purchasing; selecting, by the consumer via the application, two or more store locations where the selected product or service is available; determining, via the application, estimated times for the selected product to be picked up or for the selected service to be completed at each of the selected store locations; selecting, by the consumer via the application, based upon the estimated times, one of the store locations for ordering or purchasing the selected product or service; and ordering or purchasing, by the consumer via the application, the selected product or service at the selected store location.

A system for implementing a time saving method for a consumer includes a consumer computer device in communications with a company server via a network, and a software application for facilitating the communications between the computer device and the server. The software application: enables the consumer to order or purchase products or services available from a company by prompting for selection by the consumer of one of the available products or services for consideration of ordering or purchasing; prompts the consumer for selection of two or more store locations where the selected product or service is available; determines estimated times for the selected product to be picked up or for the selected service to be completed at each of the selected store locations; prompts the consumer for selection, based upon the estimated times, of one of the store locations for ordering or purchasing the selected product or service; and prompts the consumer to finalize an order or purchase of the selected product or service at the selected store location.

A computer program product for use with a computerized device includes a computer readable storage medium having computer readable program code embodied therewith. The computer readable program code includes: code configured to access, by consumer interaction, a computer application for ordering or purchasing products or services available from a company using a computer device connected to a wireless network; code configured to select, by consumer interaction via the application, one of the available products or services for consideration of ordering or purchasing; code configured to select, by consumer interaction via the application, two or more store locations where the selected product or service is available; code configured to determine, via the application, estimated times for the selected product to be picked up or for the selected service to be completed at each of the selected store locations; code configured to select, by consumer interaction via the application, based upon the estimated times, one of the store locations for ordering or purchasing the selected product or service; and code configured to order or purchase, by consumer interaction via the application, the selected product or service at the selected store location.

The above and other aspects of various embodiments of the present invention will become apparent in view of the following description, claims and drawings.

### BRIEF DESCRIPTION OF THE SEVERAL VIEWS OF THE DRAWINGS

The accompanying drawings, in which like numerals indicate like structural elements and features in various figures, are not necessarily drawn to scale, the emphasis instead being placed upon illustrating the principles of the invention.

FIG. 1 is a flowchart diagram of a preferred embodiment of a method in accordance with the principles of the invention; and

FIG. 2 is a block diagram of a system for implementing the method of the invention.

### DETAILED DESCRIPTION

In the following description, specific details are set forth although it should be appreciated by one of ordinary skill that the systems and methods can be practiced without at least some of the details. In some instances, known features or processes are not described in detail so as not to obscure the present invention.

As will be appreciated by one skilled in the art, the present invention may be embodied as a method, system, or computer program product. Accordingly, the present invention may take the form of an entirely hardware embodiment, or an entirely software embodiment, including firmware, resident software, micro-code, etc., or an embodiment combining software and hardware aspects that may all generally be referred to herein as a “circuit”, “module” or “system”.

Furthermore, the invention may take the form of a computer program product accessible from a computer-usable or computer-readable medium providing program code for use by, or in connection with, a computer or any instruction system. For the purposes of this description, a computer-usable or computer-readable medium can be any apparatus that can contain, store, communicate, propagate, or transport the program for use by, or in connection with, the instruction execution system, apparatus, or device.

Any suitable computer-usable or computer-readable medium may be utilized. For example, the medium can include, but is not limited to, an electronic, magnetic, optical, electromagnetic, infrared, or semiconductor system (or apparatus or device), or a propagation medium. A non-exhaustive list of exemplary computer-readable media can include an electrical connection having one or more wires, an optical fiber, magnetic storage devices such as magnetic tapes, a removable computer diskette, a portable computer diskette, a hard disk, a rigid magnetic disk, a magneto-optical disk, an optical storage medium, such as an optical disk including a compact disk read only memory (CD-ROM), a compact disk read/write (CD-R/W), or a DVD, or a semiconductor or solid state memory including, but not limited to, a random access memory (RAM), a read-only memory (ROM), or an erasable programmable read-only memory (EPROM or Flash memory).

A computer-usable or computer-readable medium further can include a transmission media such as those supporting the Internet or an intranet. Further, the computer-usable medium may include a propagated data signal with the computer-usable program code embodied therewith, either in baseband or as part of a carrier wave. The computer-usable program code may be transmitted using any appropriate medium, including but not limited to the Internet, wireline, optical fiber, cable, RF, etc.

In another aspect, the computer-usable or computer-readable medium can be paper or another suitable medium upon which the program is printed, as the program can be electronically captured, via, for instance, optical scanning of the paper or other medium, then compiled, interpreted, or otherwise processed in a suitable manner if necessary, and then stored in a computer memory.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's mobile device, partly on the user's mobile device, as a stand-alone software package, partly on the user's device and partly on a remote computer, or entirely on the remote computer or server. In the latter scenario, the remote computer may be connected to the user's device through a local area network (LAN) or a wide area network (WAN), or the connection may be made to an external computer (for example, through the Internet using an Internet Service Provider).

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, printing, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems, and Ethernet cards are just a few of the currently available types of network adapters.

The present invention is described below with reference to flowchart illustrations and/or block diagrams of methods, apparatus devices and systems and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, mobile computing device, or other programmable data processing apparatus to produce a machine, such that the instructions, which execute via the processor of the computer or other programmable data processing apparatus, create means for implementing the functions/acts specified in the flowchart and/or block diagram block or blocks.

The computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer device or other programmable data processing apparatus to cause a series of operational steps to be performed on the computer device or other programmable apparatus to produce a computer implemented process such that the instructions which execute on the computer device or other programmable apparatus provide steps for implementing the functions/acts specified in the flowchart and/or block diagram block or blocks.

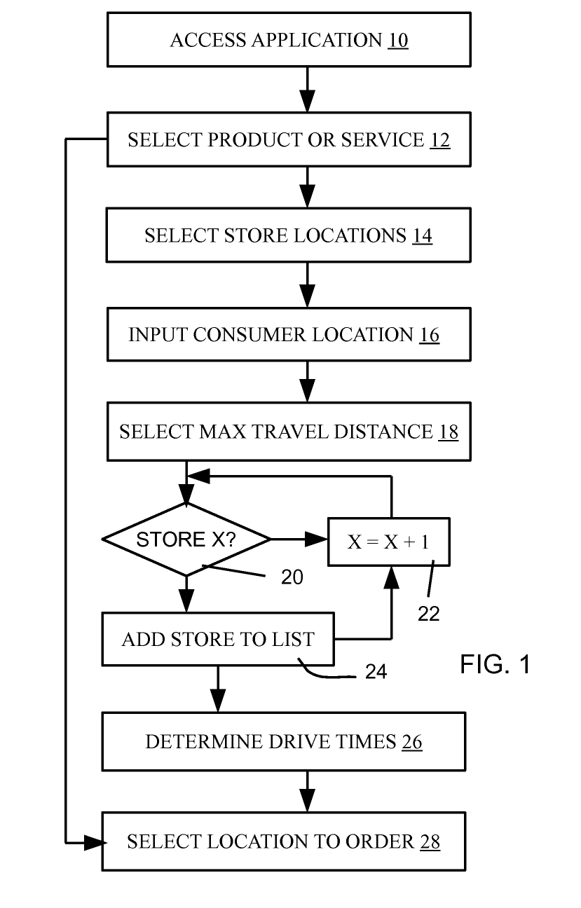

A computer implemented consumer time saving method in accordance with the principles of the invention is described in FIG. 1. For example, a consumer (i.e. user) may desire to refill a prescription at a pharmacy having a chain of locations. In order to access the automated system and method, the consumer must have access to a computer such as a desktop computer, a laptop computer, a tablet computer, a smart phone, a mobile device or any similar computerized device which has networking communications availability.

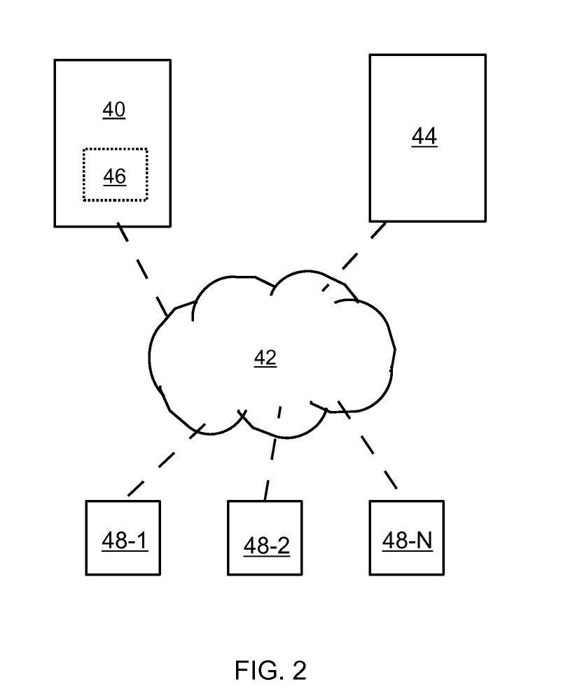

FIG. 2 illustrates an exemplary system for implementing the method of FIG. 1 including a mobile device 40 which has wireless networking capability to communicate with a company computer/server 44 through a wireless network 42. In this example, the wireless network is the Internet although any network whether wireless or wired could be considered. The computer/server 44 is the main pharmacy company server which in turn is in communications (either wired or preferably wireless) with computers 48-1 . . . 48-N located at each pharmacy location within the chain of stores, whereby N equals the number of stores in the chain.

Turning back to FIG. 1, a consumer wishing to refill a prescription would first in step 10 access a prescription refill software application that could be resident on his/her computer or mobile device, or could be resident on the company server 44. The application would be available for download from the company website. Of course, the consumer would need to set up a login account with the company via the Internet/network which would include security information such as a login name and password.

After logging in the application prompts the consumer with a number of selections or requests. In the current example the consumer is first prompted to select a specific product or service in step 12. Here the consumer will select the desired service as “refilling a prescription”. However any service available from the store chain can be listed here for selection. Queued services which often require waiting in a line or queue are particularly applicable for listing here. Examples of queued services include: automobile repair or service including state inspection stickers, oil change, tire rotation, etc.; food and bakery orders, especially large orders or special orders such as personalized birthday cakes, etc.; and any other queued services.

The consumer selects a service to be rendered, or a product for delivery or pick-up at a store from the lists offered in step 12. For example, if the consumer wishes to purchase an item that requires assembly, or if the consumer wishes to pay an extra fee for a store employee to assemble a product, then the assembly time is taken into account before the product is ready for delivery or pick-up.

Service or product availability is another concern. If the service is temporarily unavailable, or if the product is temporarily out of stock, then the next available service or delivery date and time can be estimated by the application. Also, it is likely that a selected service or product will have varied availability for completion, pick-up or delivery from one store to another.

After selecting the product or service in step 12 the consumer has the option of selecting one specific store location for product pick-up or service. In this case the application would move directly to step 28 where the user would select the store location and complete the order. Alternatively, the consumer would consider more than one store location for product pick-up or service as described below.

The application in step 14 prompts the consumer to select two or more store locations at which to consider ordering the selected product or service. As an aid to the consumer in determining which store location would provide the desired product or service and which store location would be most convenient and expeditious for completing the purchase order, the application could determine travel distances and travel times from the consumer's location to the various selected stores. Optionally, the consumer could input his/her current location or a default store location in step 16, plus a desired travel radius (e.g. 30 miles) or travel time (e.g. 30 minutes) in step 18 and the application could present a list to the consumer of store locations within the drive radius. The application could also provide information as to which of the selected stores the specific product or service of interest is available.

In step 18 the consumer can select a desired maximum travel distance or travel time to a store. The application in step 20 will determine whether a first store in the queue of stores is within the desired range of the consumer. If so, that store is added in step 24 to the list of stores that meets the consumer's requirements. The application then increments in step 22 to the next store in the queue of stores, etc. until all of the stores have been considered. The drive times for the consumer from his/her location to each of the selected stores on the list of step 24 is determined in step 26 with the results presented to the user together with the estimated times when the product will be available for pick-up or when the service can be started and/or completed. The consumer in step 28 can then select one specific store location from the list at which to order the product or service.

The order of the steps of the inventive method can vary in different embodiments. For example in the method of FIG. 2, a consumer could first input his/her consumer location shown as step 16 prior to the selection of store locations shown in step 14, or perhaps as soon as the application was accessed. Other step ordering could also be implemented to the method.

Any computer program product having a computer readable storage medium with computer readable program code embodied therewith for use with a computerized device as previously described can be used to implement the invention. The computer readable program code is configured to: access, by consumer interaction, a computer application for ordering or purchasing products or services available from a company using a computer device connected to a wireless network; select, by consumer interaction via the application, one of the available products or services for consideration of ordering or purchasing; select, by consumer interaction via the application, two or more store locations where the selected product or service is available; determine, via the application, estimated times for the selected product to be picked up or for the selected service to be completed at each of the selected store locations; select, by consumer interaction via the application, based upon the estimated times, one of the store locations for ordering or purchasing the selected product or service; and order or purchase, by consumer interaction via the application, the selected product or service at the selected store location.

The code can also be configured to: input, by consumer interaction via the application, a consumer location; select, by consumer interaction via the application, a maximum travel distance or a maximum travel time from the consumer location to locate additional store locations; select, by consumer interaction via the application, store locations where the selected product or service is available within the maximum travel distance or the maximum travel time from the consumer location; determine via the application approximate drive times from the consumer location to each of the selected store locations; and select, by consumer interaction via the application, based upon product or service availability and the approximate drive times, one of the store locations for ordering or purchasing the selected product or service.

While the invention has been shown and described with reference to specific embodiments, it should be understood by those skilled in the art that various changes in form and detail may be made therein without departing from the spirit and scope of the invention.

What is claimed is:

1. A computer implemented consumer time saving method comprising:
accessing, by a consumer, a computer application for ordering or purchasing products or services available from a company using a computer device connected to a wireless network;
selecting, by the consumer via the application, one of the available products or services for consideration of ordering or purchasing;
selecting, by the consumer via the application, two or more store locations where the selected product or service is available;
determining, via the application, estimated times for the selected product to be picked up or for the selected service to be completed at each of the selected store locations;
selecting, by the consumer via the application, based upon the estimated times, one of the store locations for ordering or purchasing the selected product or service; and
ordering or purchasing, by the consumer via the application, the selected product or service at the selected store location.

2. The computer implemented consumer time saving method of claim 1, further comprising:
inputting, by the consumer via the application, a consumer location;
selecting, by the consumer via the application, a maximum travel distance or a maximum travel time from the consumer location to locate additional store locations;
selecting, by the consumer via the application, store locations where the selected product or service is available within the maximum travel distance or the maximum travel time from the consumer location;
determining approximate drive times from the consumer location to each of the selected store locations; and
selecting, by the consumer via the application, based upon product or service availability and the approximate drive times, one of the store locations for ordering or purchasing the selected product or service.

3. The computer implemented consumer time saving method of claim 1, wherein the products comprise prescription drugs.

4. The computer implemented consumer time saving method of claim 1, wherein the services comprise auto repair, auto maintenance, bakery services, deli services and food services.

5. The computer implemented consumer time saving method of claim 2, wherein the step of selecting one of the store locations for ordering or purchasing further comprises summing the estimated time for the selected service to be completed and the approximate drive time for each of the store locations.

6. The computer implemented consumer time saving method of claim 1, wherein the application is located on a mobile computer device, a computer, a smart phone, a tablet computer, a laptop computer or a company webpage.

7. A system for implementing a time saving method for a consumer, the system comprising:
a consumer computer device in communications with a company server via a network; and
a software application for facilitating the communications between the computer device and the server, said software application enabling the consumer to order or purchase products or services available from a company by
prompting for selection by the consumer of one of the available products or services for consideration of ordering or purchasing,
prompting for selection by the consumer of two or more store locations where the selected product or service is available,
determining estimated times for the selected product to be picked up or for the selected service to be completed at each of the selected store locations,
prompting for selection by the consumer, based upon the estimated times, of one of the store locations for ordering or purchasing the selected product or service; and
prompting for the consumer to finalize an order or purchase of the selected product or service at the selected store location.

8. The system of claim 7, said software application further enabling:
input by the consumer, of a consumer location;
selection by the consumer, of a maximum travel distance or a maximum travel time from the consumer location to locate additional store locations;
selection by the consumer, of store locations where the selected product or service is available within the maximum travel distance or the maximum travel time from the consumer location;
determination of approximate drive times from the consumer location to each of the selected store locations; and
selection by the consumer, based upon product or service availability and the approximate drive times, of one of the store locations for ordering or purchasing the selected product or service.

9. The system of claim 7, wherein the products comprise prescription drugs.

10. The system of claim 7, wherein the services comprise auto repair, auto maintenance, bakery services, deli services and food services.

11. The system of claim 8, wherein the software application selection of one of the store locations for ordering or purchasing the selected product or service further comprises summing the estimated time for the selected service to be completed and the approximate drive time for each of the store locations.

12. The system of claim 7, wherein consumer computer device is a mobile computer device, a personal computer, a smart phone, a tablet computer or a laptop computer and the network is a wireless network.

13. A computer program product for use with a computerized device, comprising:
a computer readable storage medium having computer readable program code embodied therewith, the computer readable program code comprising:
computer readable program code configured to access, by consumer interaction, a computer application for ordering or purchasing products or services available from a company using a computer device connected to a wireless network;
computer readable program code configured to select, by consumer interaction via the application, one of the available products or services for consideration of ordering or purchasing;
computer readable program code configured to select, by consumer interaction via the application, two or more store locations where the selected product or service is available;
computer readable program code configured to determine, via the application, estimated times for the selected product to be picked up or for the selected service to be completed at each of the selected store locations;
computer readable program code configured to select, by consumer interaction via the application, based upon the estimated times, one of the store locations for ordering or purchasing the selected product or service; and
computer readable program code configured to order or purchase, by consumer interaction via the application, the selected product or service at the selected store location.

14. The computer program product of claim 13 further comprising computer readable program code configured to:
input, by consumer interaction via the application, a consumer location;
select, by consumer interaction via the application, a maximum travel distance or a maximum travel time from the consumer location to locate additional store locations;
select, by consumer interaction via the application, store locations where the selected product or service is available within the maximum travel distance or the maximum travel time from the consumer location;
determine via the application approximate drive times from the consumer location to each of the selected store locations; and
select, by consumer interaction via the application, based upon product or service availability and the approximate drive times, one of the store locations for ordering or purchasing the selected product or service.

15. The computer program product of claim 13 wherein the products comprise prescription drugs.

16. The computer program product of claim 13 wherein the services comprise auto repair, auto maintenance, bakery services, deli services and food services.

17. The computer program product of claim 14 wherein the computer readable program code configured to select, one of the store locations for ordering or purchasing further comprises summing the estimated time for the selected service to be completed and the approximate drive time for each of the store locations.

18. The computer program product of claim 13 wherein the application is located on a mobile computer device, a computer, a smart phone, a tablet computer, a laptop computer or a company webpage.
